(19) United States
(12) Patent Application Publication
(10) Pub. No.: US 2021/0225339 A1
(43) Pub. Date: Jul. 22, 2021

(54) DRUM PAD HOLDER

(71) Applicant: MM-Distribution Oy, Helsinki (FI)

(72) Inventor: Matti MUHOS, Helsinki (FI)

(21) Appl. No.: 17/148,211

(22) Filed: Jan. 13, 2021

(30) Foreign Application Priority Data
Jan. 17, 2020 (FI) 20205046

(51) Int. Cl. G10D 13/10; G10D 13/02

(52) U.S. Cl. CPC G10D 13/28; G10D 13/02

(57) ABSTRACT

The invention relates to the field of musical instruments and percussion musical instruments in general, particularly to support accessories of percussion musical instruments, and more particularly to a drum pad holder. The drum pad holder (2) according to the present invention is arranged for holding a drum pad (1), said drum pad holder (2) comprising a base element (40), which base element (40) is arranged fastenable to a thigh of a user, an adjustable arm arrangement, and a head element (30); in which drum pad holder (2) said head element (30) comprises a head pin (32) arranged for holding said drum pad (1), said head pin (32) comprising a securing arrangement for securing said drum pad (1) in place.

### FIELD OF THE INVENTION

The invention relates to the field of musical instruments and percussion musical instruments in general, particularly to support accessories of percussion musical instruments, and more particularly to a drum pad holder.

### BACKGROUND OF THE INVENTION

Percussion musical instruments are musical instruments that are sounded by being struck or scraped e.g. beater such as a drum stick. The most common percussion instruments in the orchestra include e.g. the timpani, xylophone, cymbals, triangle, snare drum, bass drum, cymbals, triangle, tambourine, maracas, gongs, chimes and celesta.

A drum pad is a percussion implement utilized by drummers to quietly practice or warm up before a performance. There are drum pads adapted for the needs of different percussion drums. Drum pads typically include an actual disk of drumhead material or similar element fixed to an underlying rigid surface with a rim of metal or plastic. Drum pads approximate the stretch and reflection with a response, bounce and feel similar to that a true drumhead when struck. A drum pad is typically designed compact, thin and lightweight for ease in transport.

The most common types of drum pads are the standard, single snare drum pads. Typically, a drum pad is mounted on a drum stand, placed between the player's knees and played with drum sticks. Drums stands are not easy to carry along for travel or transport. Likewise, a drum stand as a drum pad holder requires a considerable space when in use.

There is a clear need among drummers and percussionists for an improved solution for a drum pad holder, which drum pad holder would be easy to transport or travel with, and which drum pad holder would not require much space when in use.

### BRIEF DESCRIPTION OF THE INVENTION

The object of the invention is to introduce an improved solution for a drum pad holder, which would be easy transport or travel with, and which drum pad holder would not require much space when in use. Advantageous embodiments are furthermore presented.

It is brought forward a new drum pad holder arranged for holding a drum pad, which drum pad holder comprises: a base element, which base element is arranged fastenable to a thigh of a user, an adjustable arm arrangement, and a head element; wherein said head element comprises a head pin arranged for holding said drum pad, said head pin comprising a securing arrangement for securing said drum pad in place. Hereby, one or more of the above-mentioned advantages and/or objectives are achieved. These advantages and/or objectives are further facilitated with the additional preferred features and/or steps described in the following.

In a preferred embodiment, said adjustable arm arrangement comprises an outer arm and an at least one inner arm extendable from said outer arm.

In a preferred embodiment, said adjustable arm arrangement comprises an outer arm and one inner arm extendable from said outer arm.

In a preferred embodiment, said drum pad holder comprises an at least one fastening element for fastening of said base element to a thigh of a user.

In a preferred embodiment, said an at least one fastening element comprises a belt or a strap together with a securing arrangement.

In a preferred embodiment, said base element comprise a support element supporting the fastening of the base element to a thigh of a user.

In a preferred embodiment, said support element comprises slot/slots suited for said at least one fastening element to go through.

In a preferred embodiment, said securing arrangement of said head pin is a thread of said head pin.

In a preferred embodiment, said outer arm comprises a base joint arranged fastenable to said base element.

In a preferred embodiment, said base joint comprises a ball protrusion, which ball protrusion is arranged fitting to a counterpart position in said base element.

In a preferred embodiment, said base element comprises outer arm tightening member/members arranged for tightening said outer arm in its adjusted position.

In a preferred embodiment, said outer arm comprises inner arm tightening member/members arranged for tightening said inner arm in its adjusted position.

In a preferred embodiment, said inner arm comprises an upper joint arranged fastenable to said head element.

In a preferred embodiment, said head element comprises head element fastening member/members arranged for fastening said head element in its adjusted position.

In a preferred embodiment, said drum pad is arranged for drumming practice.

### BRIEF DESCRIPTION OF THE DRAWINGS

In the following, the present invention will be described in more detail by way of example and with reference to the attached drawings, in which:

FIG. 1 illustrates a conceptual diagram of a drum pad holder according to one embodiment of the present invention.

FIG. 2 illustrates a drummer practicing drumming using a drum pad and a drum pad holder according to one embodiment of the present invention.

FIG. 3 illustrates a front view of a drum pad holder according to one embodiment of the present invention.

FIG. 4 illustrates a backside view of a drum pad holder according to one embodiment of the present invention.

FIG. 5 illustrates a right side view of a drum pad holder according to one embodiment of the present invention.

FIG. 6 illustrates a left side view of a drum pad holder according to one embodiment of the present invention.

FIG. 7 illustrates a cross-sectional view of a drum pad holder according to one embodiment of the present invention.

FIG. 8 illustrates a left side view of an extended drum pad holder according to one embodiment of the present invention.

FIG. 9 illustrates a cross-sectional view of an extended drum pad holder according to one embodiment of the present invention.

The foregoing aspects, features and advantages of the invention will be apparent from the drawings and the detailed description related thereto.

### DETAILED DESCRIPTION

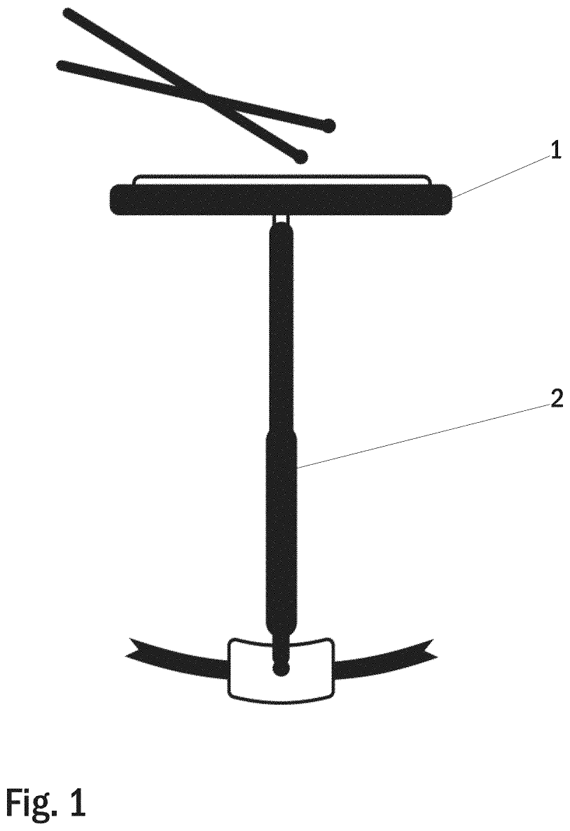

FIG. 1 illustrates a simple diagram of a drum pad holder according to one embodiment of the present invention. The drum pad holder 2 according to the present invention is arranged for holding a drum pad 1. The drum pad holder 2 according to the presented embodiment holding the drum pad 1 in place so that a drummer can use the drum pad 1 for drumming practice.

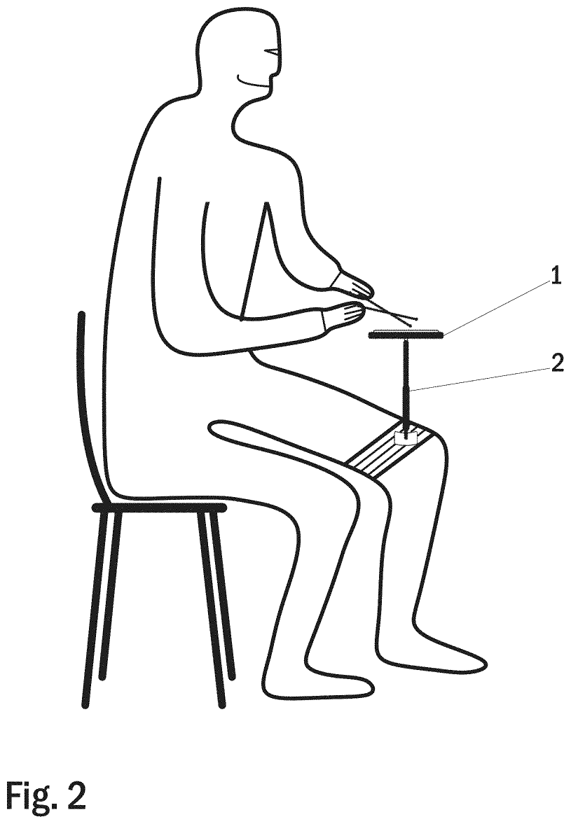

FIG. 2 illustrates a drummer practicing drumming using a drum pad and a drum pad holder according to one embodiment of the present invention. In FIG. 2, a drummer has fastened a drum pad holder 2 according to the present invention to his thigh just above the knee. The drum pad holder 2 according to the presented embodiment holds the drum pad 1 in place so that a drummer can use the drum pad 1 for drumming practice.

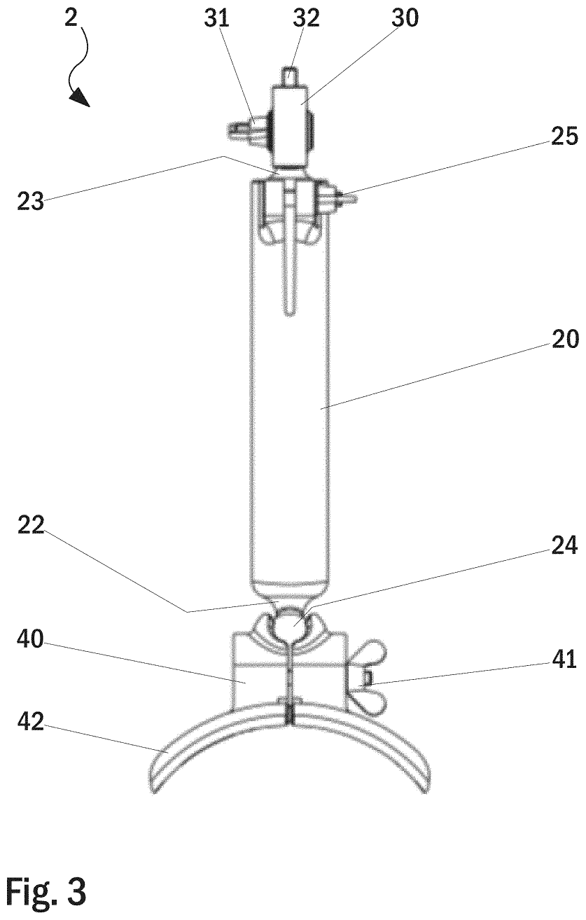

FIG. 3 illustrates a front view of a drum pad holder according to one embodiment of the present invention. The drum pad holder 2 according to the presented embodiment comprises a base element 40, an adjustable arm arrangement and a head element 30.

The adjustable arm arrangement of the drum pad holder 2 according to the present invention may comprise an outer arm 20 and an at least one inner arm extendable from said outer arm 20. In the presented embodiment, said adjustable arm arrangement of the drum pad holder 2 comprises one inner arm of said at least one inner arm extendable from said outer arm 20.

The base element 40 of the drum pad holder 2 according to the presented embodiment is arranged fastenable to a thigh of a user. Said base element 40 may comprise a support element 42 supporting the fastening of the base element 40 to a thigh of a user. The drum pad holder 2 according to the presented embodiment may also comprise an at least one fastening element for fastening of said base element 40 to a thigh of a user. Said at least one fastening element is not shown in FIG. 3.

Said at least one fastening element may be a belt or a strap together with a securing arrangement designed to secure said belt or said strap so that said base element 40 is properly fastened to a thigh of a user. Said securing arrangement may be a buckle, snap, button, fabric fastener or any other securing arrangement. Said belt or said strap may be made of organic material or of plastic or composite material. Said organic material may e.g. be leather, organic fabric or rubber. Said plastic or composite material may comprise polymer, polyethylene, polythene, acrylics, celluloses, nylons, ethylene, polymers, vinyl ester polymers, polyvinyl acetals, phenolics, urea resins, caseins, alkyds, neoprene and/or rubber.

The outer arm 20 of the drum pad holder 2 according to the presented embodiment comprises a base joint 22 in its bottom side, which base joint 22 is arranged fastenable to said base element 40. In the presented embodiment, the base joint 22 comprises a ball protrusion 24, which ball protrusion is arranged fitting to a counterpart position in said base element 40.

Said base element 40 of the presented embodiment comprises outer arm tightening member/members 41, said outer arm tightening member/members 41 arranged for tightening said outer arm 20 in its adjusted position. In the presented embodiment, said outer arm tightening member/members 41 is/are arranged for tightening said ball protrusion 24 of the base joint 22, thereby tightening said outer arm 20 in its adjusted position.

The inner arm of said adjustable arm arrangement may be extended from said outer arm 20 of the drum pad holder 2 according to the presented embodiment. Said outer arm 20 of the presented embodiment comprises inner arm tightening member/members 25 arranged for tightening said inner arm in its adjusted position.

The inner arm of said adjustable arm arrangement of the drum pad holder 2 according to the presented embodiment comprises an upper joint 23 in its upper side, which upper joint 23 is arranged fastenable to said head element 30. In the presented embodiment, the head element 30 comprises head element fastening member/members 31, said head element fastening member/members 31 arranged for fastening said head element 30 in its adjusted position.

The head element 30 of the drum pad holder 2 according to the present invention is arranged for holding a drum pad. In the presented embodiment, said head element 30 comprises a head pin 32, said head pin 32 arranged for holding a drum pad. Said head pin 32 may comprise a thread or another securing arrangement for securing a drum pad in place.

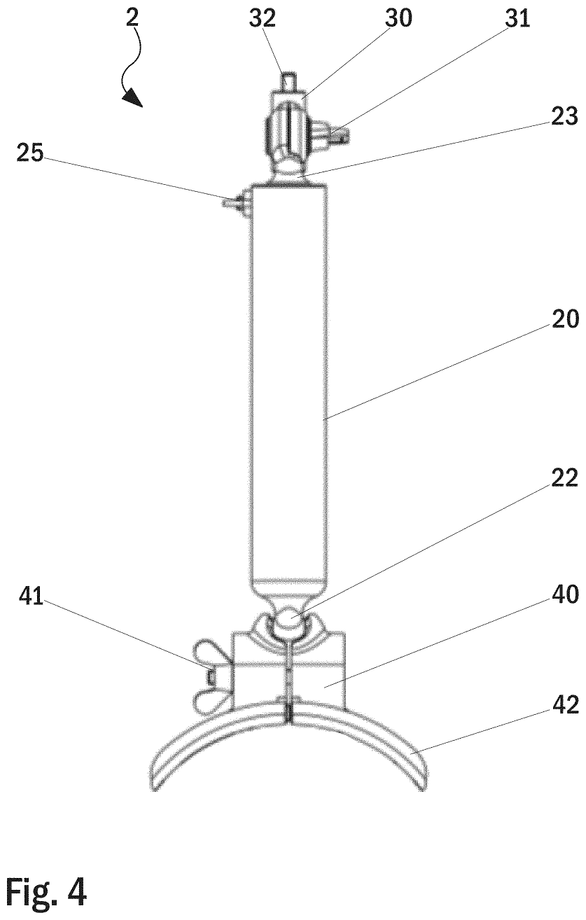

FIG. 4 illustrates a backside view of a drum pad holder according to one embodiment of the present invention. The drum pad holder 2 according to the presented embodiment comprises a base element 40, an adjustable arm arrangement and a head element 30. In the presented embodiment, said adjustable arm arrangement of the drum pad holder 2 comprises an outer arm 20 and one inner arm extendable from said outer arm 20. Said base element 40 may comprise a support element 42 for supporting the fastening of the base element 40 to a thigh of a user, and at least one fastening element for fastening of said base element 40 to a thigh of a user. Said at least one fastening element is not shown in FIG. 3.

The outer arm 20 of the drum pad holder 2 according to the presented embodiment comprises a base joint 22 in its bottom side, which base joint 22 is arranged fastenable to said base element 40. Said base element 40 of the presented embodiment comprises outer arm tightening member/members 41, said outer arm tightening member/members 41 arranged for tightening said outer arm 20 in its adjusted position. Said outer arm 20 of the presented embodiment comprises inner arm tightening member/members 25 arranged for tightening said inner arm in its adjusted position.

The inner arm of said adjustable arm arrangement of the drum pad holder 2 according to the presented embodiment comprises an upper joint 23 in its upper side, which upper joint 23 is arranged fastenable to said head element 30. The head element 30 comprises head element fastening member/members 31, said head element fastening member/members 31 arranged for fastening said head element 30 in its adjusted position. In the presented embodiment, said head element 30 comprises a head pin 32, said head pin 32 arranged for holding a drum pad. Said head pin 32 may comprise a thread or another securing arrangement for securing a drum pad in place.

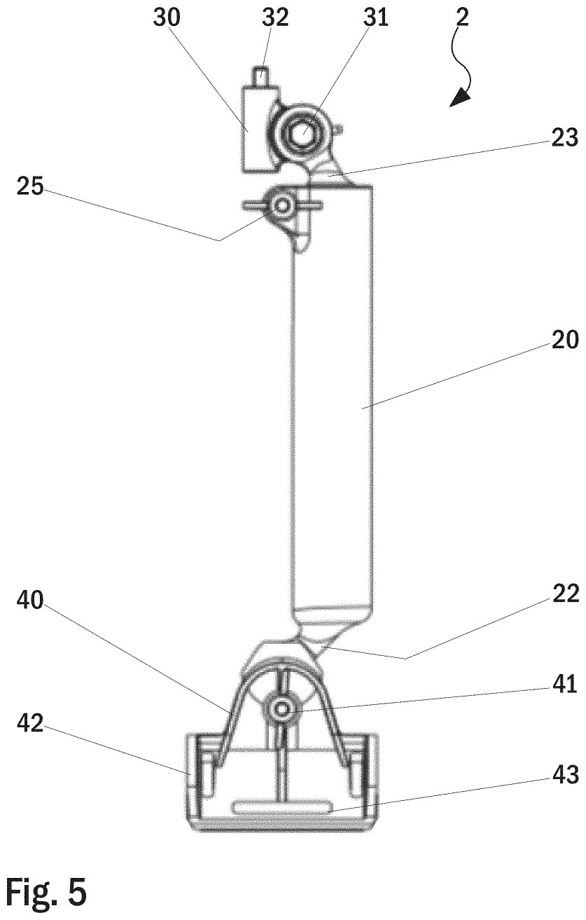

FIG. 5 illustrates a right side view of a drum pad holder according to one embodiment of the present invention. The drum pad holder 2 according to the presented embodiment comprises a base element 40, an adjustable arm arrangement and a head element 30. Said base element 40 comprises outer arm tightening member/members 41. Said adjustable arm arrangement comprises an outer arm 20 and one inner arm extendable from said outer arm 20. The outer arm 20 comprises inner arm tightening member/members 25, and a base joint 22 fastenable to said base element 40. The inner arm comprises an upper joint 23 arranged fastenable to said head element 30. The head element 30 comprises head element fastening member/members 31, and a head pin 32 for holding a drum pad.

The base element 40 of the drum pad holder 2 according to the presented embodiment is arranged fastenable to a thigh of a user. Said base element 40 may comprise a support element 42 supporting the fastening of the base element 40 to a thigh of a user. The drum pad holder 2 according to the presented embodiment may also comprise an at least one fastening element for fastening of said base element 40 to a thigh of a user. Said support element 42 according to the presented embodiment comprises slot/slots 43, which slot/slots 43 are suited for said at least one fastening element to go through. Said at least one fastening element is not shown in FIG. 5. Said at least one fastening element may comprise a belt or a strap suited to go through slot/slots 43, and a buckle, snap, button, fabric fastener or any other securing arrangement, designed to secure said belt or said strap so that said base element 40 is properly fastened to a thigh of a user. Said belt or said strap may be made of organic material or of plastic or composite material. Said organic material may e.g. be leather, organic fabric or rubber. Said plastic or composite material may comprise polymer, polyethylene, polythene, acrylics, celluloses, nylons, ethylene, polymers, vinyl ester polymers, polyvinyl acetals, phenolics, urea resins, caseins, alkyds, neoprene and/or rubber.

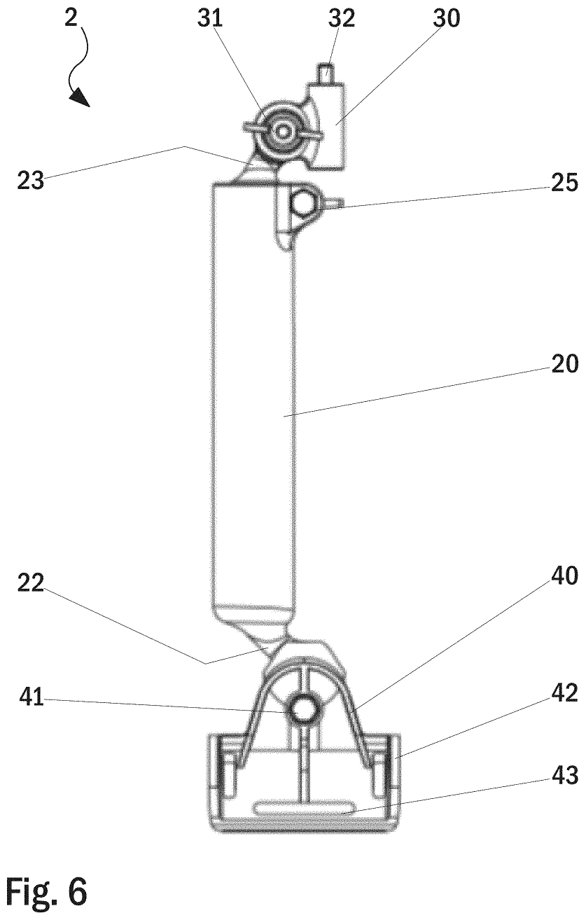

FIG. 6 illustrates a left side view of a drum pad holder according to one embodiment of the present invention. The drum pad holder 2 according to the presented embodiment comprises a base element 40, an adjustable arm arrangement and a head element 30. Said base element 40 comprises outer arm tightening member/members 41 and a support element 42, said support element 42 comprising slot/slots 43. Said adjustable arm arrangement comprises an outer arm 20 and one inner arm extendable from said outer arm 20. The outer arm 20 comprises inner arm tightening member/members 25, and a base joint 22 fastenable to said base element 40. The inner arm comprises an upper joint 23 arranged fastenable to said head element 30. The head element 30 comprises head element fastening member/members 31, and a head pin 32 for holding a drum pad.

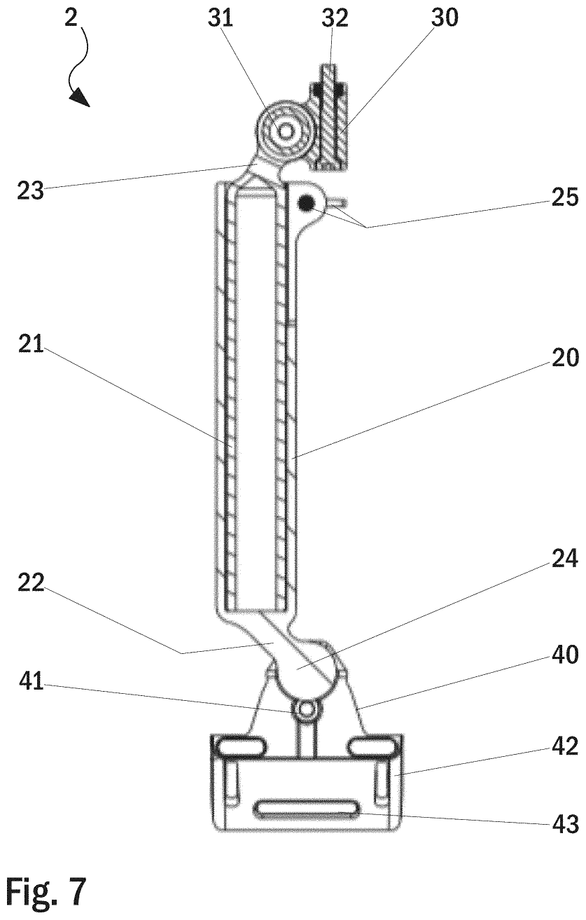

FIG. 7 illustrates a cross-sectional view of a drum pad holder according to one embodiment of the present invention. The drum pad holder 2 according to the presented embodiment comprises a base element 40, an adjustable arm arrangement and a head element 30. Said base element 40 comprises outer arm tightening member/members 41 and a support element 42, said support element 42 comprising slot/slots 43.

The adjustable arm arrangement of the drum pad holder 2 according to the present invention may comprise an outer arm 20 and an at least one inner arm extendable from said outer arm 20. In the presented embodiment, said adjustable arm arrangement of the drum pad holder 2 comprises one inner arm 21 of said at least one inner arm extendable from said outer arm 20. The inner arm 21 and the outer arm 20 may be made of any metal, metal alloy, plastic or composite material.

The outer arm 20 comprises inner arm tightening member/members 25, and a base joint 22 fastenable to said base element 40. The inner arm 21 comprises an upper joint 23 arranged fastenable to said head element 30. The head element 30 comprises head element fastening member/members 31, and a head pin 32 for holding a drum pad. In the presented embodiment, the head pin 32 comprises a threaded bolt.

In the presented embodiment, said base joint 22 comprises a ball protrusion 24, which ball protrusion is arranged fitting to a counterpart position in said base element 40. In the presented embodiment, said outer arm tightening member/members 41 is/are arranged for tightening said ball protrusion 24 of the base joint 22, thereby tightening said outer arm 20 in its adjusted position.

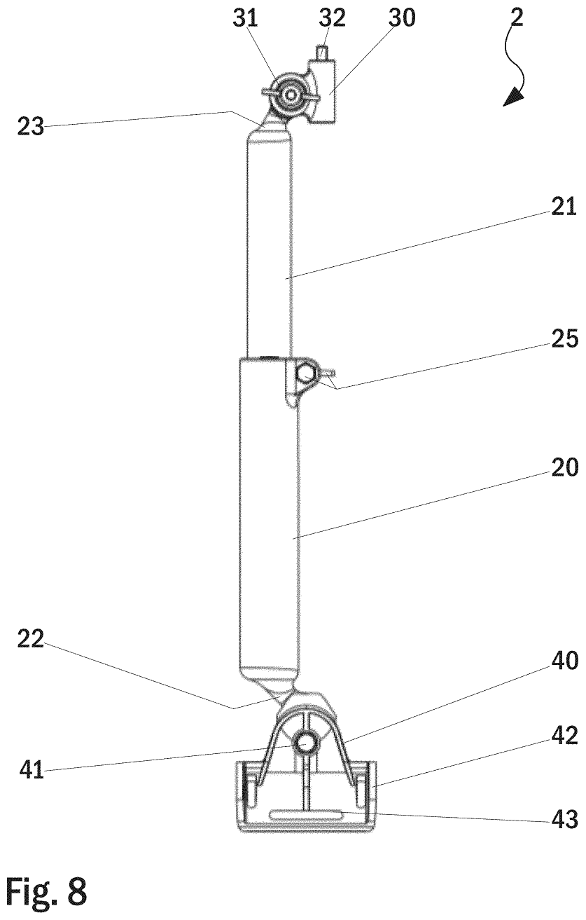

FIG. 8 illustrates a left side view of an extended drum pad holder according to one embodiment of the present invention. The drum pad holder 2 according to the presented embodiment comprises a base element 40, an adjustable arm arrangement and a head element 30. Said base element 40 comprises outer arm tightening member/members 41 and a support element 42, said support element 42 comprising slot/slots 43.

In the presented embodiment, said adjustable arm arrangement of the drum pad holder 2 according to the present embodiment comprises an outer arm 20 and one inner arm 21 extendable from said outer arm 20. In FIG. 8, said inner arm 21 had been extended from said outer arm 20.

Said adjustable arm arrangement comprises an outer arm 20 and one inner arm extendable from said outer arm 20. The outer arm 20 comprises inner arm tightening member/members 25, and a base joint 22 fastenable to said base element 40. The inner arm 21 comprises an upper joint 23 arranged fastenable to said head element 30. The head element 30 comprises head element fastening member/members 31, and a head pin 32 for holding a drum pad.

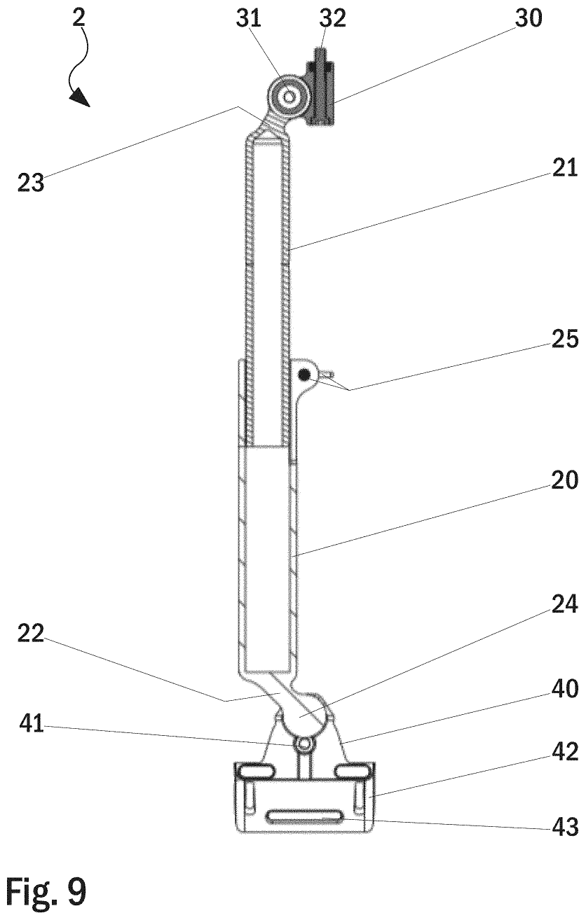

FIG. 9 illustrates a cross-sectional view of an extended drum pad holder according to one embodiment of the present invention. The drum pad holder 2 according to the presented embodiment comprises a base element 40, an adjustable arm arrangement and a head element 30. Said base element 40 comprises outer arm tightening member/members 41 and a support element 42, said support element 42 comprising slot/slots 43.

In the presented embodiment, said adjustable arm arrangement of the drum pad holder 2 according to the present embodiment comprises an outer arm 20 and one inner arm 21 extendable from said outer arm 20. In FIG. 9, said inner arm 21 had been extended from said outer arm 20. The inner arm 21 and the outer arm 20 may be made of any metal, metal alloy, plastic or composite material.

The outer arm 20 comprises inner arm tightening member/members 25, and a base joint 22 fastenable to said base element 40. The inner arm 21 comprises an upper joint 23 arranged fastenable to said head element 30. The head element 30 comprises head element fastening member/members 31, and a head pin 32 for holding a drum pad. In the presented embodiment, the head pin 32 comprises a threaded bolt. In the presented embodiment, said base joint 22 comprises a ball protrusion 24. In the presented embodiment, said outer arm tightening member/members 41 is/are arranged for tightening said ball protrusion 24 of the base joint 22, thereby tightening said outer arm 20 in its adjusted position.

A drum pad holder 2 according to the present invention may be arranged for drumming practice.

The term “drum pad” is meant to cover any percussion implement that utilized by drummers to quietly practice or warm up before a performance, or any drum pad or practice pad adapted for the needs of different percussion drums.

The term “head element” is meant to cover any upward extending element. The term “head pin” is meant to cover any upward protruding portion of said “head element”.

The term “securing arrangement” cove is meant to cover any locking, securing, fixing or fastening arrangement.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims and their equivalents.

1. A drum pad holder arranged for holding a drum pad, said drum pad holder comprising:
a base element, which base element is arranged fastenable to a thigh of a user,
an adjustable arm arrangement, and
a head element;
wherein said head element comprises a head pin arranged for holding said drum pad, said head pin comprising a securing arrangement for securing said drum pad in place.

2. A drum pad holder according to claim 1, wherein said adjustable arm arrangement comprises an outer arm and an at least one inner arm extendable from said outer arm.

3. A drum pad holder according to claim 1, wherein said adjustable arm arrangement comprises an outer arm and one inner arm extendable from said outer arm.

4. A drum pad holder according to claim 1, wherein said drum pad holder comprises an at least one fastening element for fastening of said base element to a thigh of a user.

5. A drum pad holder according to claim 4, wherein said an at least one fastening element comprises a belt or a strap together with a securing arrangement.

6. A drum pad holder according to claim 1, wherein said base element comprise a support element supporting the fastening of the base element to a thigh of a user.

7. A drum pad holder according to claim 6, wherein said support element comprises slot/slots suited for said at least one fastening element to go through.

8. A drum pad holder according to claim 1, wherein said securing arrangement of said head pin is a thread of said head pin.

9. A drum pad holder according to claim 1, wherein said outer arm comprises a base joint arranged fastenable to said base element.

10. A drum pad holder according to claim 9, wherein said base joint comprises a ball protrusion, which ball protrusion is arranged fitting to a counterpart position in said base element.

11. A drum pad holder according to claim 2, wherein said base element comprises outer arm tightening member/members arranged for tightening said outer arm in its adjusted position.

12. A drum pad holder according to claim 3, wherein said outer arm comprises inner arm tightening member/members arranged for tightening said inner arm in its adjusted position.

13. A drum pad holder according to claim 3, wherein said inner arm comprises an upper joint arranged fastenable to said head element.

14. A drum pad holder according to claim 1, wherein said head element comprises head element fastening member/members arranged for fastening said head element in its adjusted position.

15. A drum pad holder according to claim 1, wherein said drum pad is arranged for drumming practice.
